(19) United States
(12) Patent Application Publication
(10) Pub. No.: US 2026/0300974 A1
(43) Pub. Date: Oct. 1, 2026

(54) System and Method for Authenticating a Force-Post Transaction

(71) Applicant: Mastercard International Incorporated, New York, NY (US)

(72) Inventor: Swagata Chakraborty, Bhilai (IN)

(21) Appl. No.: 19/097,758

(22) Filed: Apr. 1, 2025

(51) Int. Cl. G06Q 20/40; G06Q 20/36

(52) U.S. Cl. CPC G06Q 20/401; G06Q 20/3674

(57) ABSTRACT

Various implementations described herein are directed to a system and method for authenticating and validating a force-post transaction between a user and a merchant, where the user is associated with an issuer and a merchant is associated with an acquirer. The method is implemented using a payment network, and the method includes receiving a first authentication credential configured to indicate initiation of the transaction, receiving a second authentication credential configured to confirm authorization of the transaction by the user and the merchant, and authenticating the transaction based on the first and second authentication credentials.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Force-post transactions are a type of clearing transaction that occurs without corresponding authorized approval. These transactions bypass standard security and fraud prevention mechanisms, making them a necessary but potentially risky component of payment processing. While some force-post transactions fall within permitted exceptions, others that do not adhere to proper guidelines can be exploited for fraudulent activities. This has led to significant challenges for financial institutions and payment networks.

Incidents involving fraudulent force-post transactions have raised concerns among regulators and industry stakeholders. Unauthorized force-post activities have resulted in financial disputes, liquidity issues, and increased scrutiny of payment systems. These challenges highlight the need for preventive measures to mitigate the risks associated with erroneous or fraudulent force-post transactions.

### SUMMARY

Described herein are various implementations of system and method for authenticating a force-post transaction.

Described herein are various implementations of a method for authenticating a transaction between an issuer associated with a user and an acquirer associated with a merchant. The method is implemented using a payment network comprising at least one processor in communication with a memory. The method comprises: receiving, from the issuer, a first authentication credential associated with the transaction, wherein the first authentication credential is generated by the issuer and configured to indicate an initiation of the transaction; receiving, from the acquirer, a second authentication credential associated with the transaction, wherein the second authentication credential is generated by the issuer and provided to the user for subsequent transmission to the merchant, and wherein the second authentication credential is configured to confirm authorization of the transaction by the user and the merchant; authenticating the transaction based on the first and second authentication credentials; generating an authorization response based on authenticating the transaction; and transmitting the authorization response to the issuer.

In one implementation, the transaction is a force-post transaction.

In one implementation, receiving the first authentication credential further comprises receiving the first authentication credential from the issuer via an application programming interface.

In one implementation, the second authentication credential comprises a force-posting identifier and authorization code.

In one implementation, the second authentication credential is transmitted by the merchant to the acquirer.

In one implementation, authenticating the transaction further comprises: comparing the first authentication credential and the second authentication credential.

In one implementation, the authorization response includes approval, rejection, or request for additional verification.

In one implementation, a method for processing transactions within a transaction authentication framework includes a payment network communicatively connected between an issuer and an acquirer over a distributed computing network. The method comprises: receiving, by the issuer associated with a user, a notification of a transaction, the transaction initiated by the user and directed to a merchant associated with the acquirer; in response to receiving the notification, generating, by the issuer, a first authentication credential configured to indicate initiation of the transaction and a second authentication credential configured to confirm authorization of the transaction by the user and the merchant; transmitting, by the issuer, the first authentication credential to the payment network and the second authentication credential to the user for subsequent transmission to the merchant; receiving, by the acquirer, the second authentication credential from the merchant; transmitting, by the acquirer, the second authentication credential to the payment network; authenticating, by the payment network, the transaction based on the first and second authentication credential; generating, by the payment network, an authorization response based on authenticating the transaction; and transmitting, by the payment network, the authorization response to the issuer.

In one implementation, the transaction is a force post transaction.

In one implementation, the first authentication credential comprises a force-posting identifier and authorization code.

In one implementation, the first authentication credential is transmitted to the payment network via an application programming interface.

In one implementation, the second authentication credential comprises a force-posting identifier and authorization code.

In one implementation, the second authentication credential is transmitted by the merchant to the acquirer.

In one implementation, authenticating the transaction further comprises: comparing the first authentication credential and the second authentication credential.

In one implementation, the authorization response includes approval, rejection, or request for additional verification.

In one implementation, at least one non-transitory computer-readable storage media having computer-executable instructions embodied thereon, where when executed by an intermediary transaction processing system includes at least one processor in communication with a memory. The computer-executable instructions causes the at least one processor to: receive, from the issuer associated with a user, a first authentication credential associated with a transaction between the user and a merchant, wherein the first authentication credential is generated by the issuer and configured to indicate an initiation of the transaction; receive, from the acquirer, a second authentication credential associated with the transaction, wherein the second authentication credential is generated by the issuer and provided to the user for subsequent transmission to the merchant, and wherein the second authentication credential is configured to confirm authorization of the transaction by the user and the merchant; authenticate the transaction based on the first and second authentication credentials; generate an authorization response based on authenticating the transaction; and transmit the authorization response to the issuer.

In one implementation, the transaction is a force post transaction.

In one implementation, the first authentication credential comprises a force-posting identifier and authorization code.

In one implementation, the second authentication credential comprises a force-posting identifier and authorization code.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a system in accordance with implementations of various techniques described herein.

FIGS. 2 and 3 illustrate a sequencing diagram in accordance with implementations of various techniques described herein.

FIG. 4 illustrates a diagram of a computing system in which one or more various technologies described herein may be incorporated and practiced.

### DETAILED DESCRIPTION

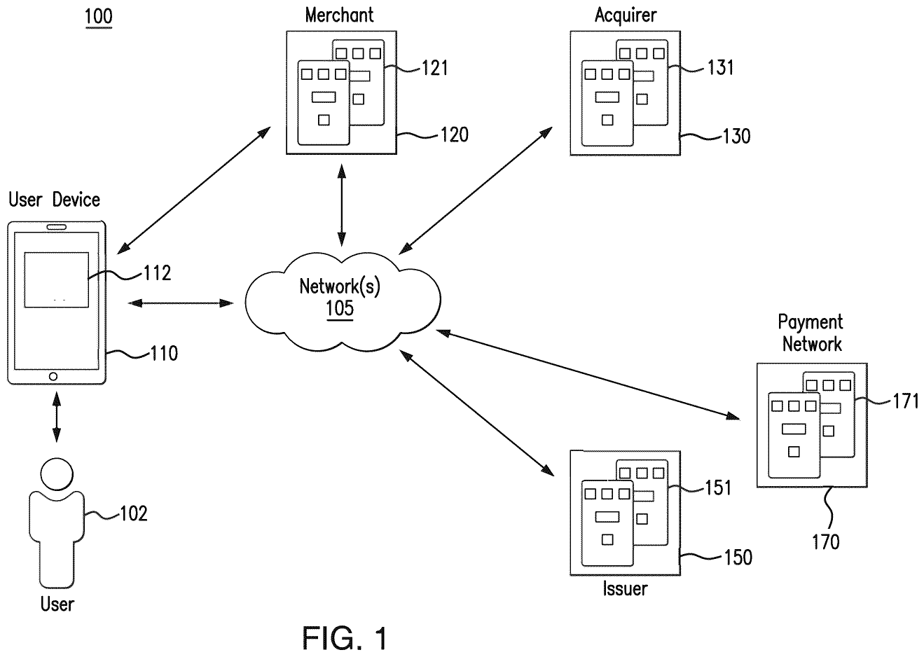

Various implementations directed to a system and method for authenticating a force-post transaction will now be described in the following paragraphs with reference to FIGS. 1-4.

As is known in the art, a user may utilize a payment account to fund various types of financial transactions, including a payment transaction with a merchant. The user may be any entity known to those skilled in the art, including, but not limited to, the following: an individual person, a family, a commercial entity, a company, a corporation, a governmental entity, a non-profit organization, and/or the like. The merchant may be an entity capable of providing one or more products for sale to the user. In particular, the merchant may be any entity known in the art, including, but not limited to, the following: an individual person, a family, a commercial entity, a company, a corporation, a governmental entity, a non-profit organization, and/or the like. The one or more products may include any good and/or service known to those skilled in the art. For example, the one or more products may include parts, material, merchandise, supplies, equipment, components, food, and/or the like.

The payment transaction may refer to a transaction by the user to purchase the one or more products from the merchant using funds from the payment account. As is known in the art, the payment transaction may be an in-person payment transaction and/or an online payment transaction between the user and the merchant. In addition, the payment account may be associated with the user (e.g., the user is the account holder) and may include any type of financial account known to those skilled in the art that can be used to fund the payment transaction. For example, the payment account may be a banking account, a checking account, a savings account, a credit card account, a debit card account, a prepaid card account, a virtual payment account, and/or the like.

In one scenario, the user may utilize a payment card in order to perform the payment transaction with the merchant. The payment card may be any type of card known in the art, including a physical card or a virtual card. Examples of the payment card may include, but are not limited to, the following: a debit card, a credit card, a prepaid card, a virtual payment card, virtual payment numbers, virtual card numbers, a foreign exchange card, a charge card, a stored-value card, and/or the like. As is known in the art, the payment card may be linked with the payment account of the user, such that the user can use the payment card to fund the payment transaction via the payment account. In particular, to perform the payment transaction using the payment card, the user may provide the merchant with data corresponding to the payment card. Such data may include data corresponding to a primary account number (PAN) for the payment card, an expiration date for the payment card, a Card Validation Code (CVC) for the payment card, and/or the like. This data corresponding to the payment card may hereinafter be referred to as payment card data.

The merchant may then further perform the payment transaction by transmitting the payment card data among one or more other entities, such as an acquirer, a payment network, and an issuer. As is known in the art, the acquirer may be a financial institution that provides one or more services for the processing of payment card-based transactions for the merchant. In addition, the payment network may refer to a network and/or collection of systems used to facilitate payment transactions for the acquirer and the issuer. As is also known in the art, the issuer may be a financial institution (e.g., a bank, a credit card company, and/or the like) that maintains the payment account for the user and issues the payment card associated with the account to the user. For a successful payment transaction, the issuer may, based on the data, provide an authorization response indicating that the payment transaction is approved. In particular, after the issuer approves the payment transaction, the payment transaction may be funded via a transfer of funds between the payment account of the user and a financial account of the merchant.

In certain situations, network connectivity disruptions or other system limitations can prevent communication between the one or more entities, requiring payment transactions between the user and the merchant to be force-posted. Force-post transactions occur when the merchant processes a payment without obtaining prior authorization from the issuer. In such cases, the merchant may perform the transaction using a previously stored or manually entered authorization code, allowing the transaction to proceed without real-time validation. The acquirer may then further perform the force-post transaction by later transmitting data (e.g., the payment card data) to the issuer via the payment network, bypassing typical authorization checks performed by the issuer for purposes of clearing and/or settlement.

For example, a user may prepare for checkout at a point-of-sale (POS) system of a merchant, and the merchant may face a network outage during checkout. The merchant may then proceed with the checkout using force posting by entering an unvalidated authorization code into the POS system. As a result, during the authorization process, there may be no payment network involvement since no real-time approval may occur. Additionally, the issuer may not be involved in the authorization process. During clearing and settlement of the transaction, the acquirer may send the transaction records to the issuer, and the issuer may process the settlement, unaware that no real-time authorization occurred. Because the issuer is not involved in the initial authorization, potential fraud, insufficient funds, or incorrect transaction details may go undetected until after the transaction has been processed. If fraud is later detected, a dispute may arise between the acquirer and the issuer.

In the current payment ecosystem, there are scenarios where acquirers perform force-post transactions due to legitimate reasons such as refunds, offline authorizations, or missed clearing timelines. However, force-post transactions are processed without issuer approval, resulting in unintended financial exposure for issuers. Currently, issuers may have no mechanism to preemptively verify or reject force-post transactions before they are processed.

This lack of control may pose significant risks to issuers, such as potential fraud, liquidity challenges, and operational disruptions. For example, an issuer may find themselves obligated to honor all clearing messages they receive, even if the transactions appear suspicious. As a result, fraudulent or erroneous force-post transactions can go undetected until financial damage has already occurred. This may lead to chargeback disputes, reputational risks for payment networks, and regulatory scrutiny.

While industry networks may use mandates and behavioral fees to curb unauthorized force-post transactions, these measures are largely post-facto and may not prevent fraudulent activity in real time. Rather, these measures impose penalties after the damage has been done. Without a proactive solution, issuers may face financial burdens, while acquirers may unknowingly or deliberately process unauthorized transactions that disrupt the integrity of the payment system.

Thus, a potential technical problem with conventional force-post transactions is that they may lack real-time verification, which may lead to fraud risks and unauthorized charges. Various implementations disclosed herein may provide a technical solution to this problem. For example, these implementations may provide a structured multi-party validation framework where a force-post transaction is linked to an issuer-generated verification identifier, which may allow for authentication even after network restoration. In addition, such implementations may enable the payment network to identify and halt unauthorized force-post transactions. Further, these implementations may allow acquirers to receive alerts when they attempt to submit unwarranted force-post transactions. By introducing validation and proactive intervention via the implementations disclosed herein, security can be enhanced, fraud may be reduced, and operation losses associated with erroneous or fraudulent force post transactions may be prevented. Although various implementations are described herein within the context of financial transactions, these implementations have broad application and may be implemented in other contexts, such as secure ticketing authorization, Internet of Things (loT) based machine-to-machine transactions, and authentication in blockchain identity management systems.

### I. System

FIG. 1 illustrates a schematic diagram of a system 100 in accordance with implementations of various techniques described herein. The system 100 may include one or more networks 105, a user 102, a user device 110, a merchant 120, an acquirer 130, an issuer 150, and a payment network 170.

The user device 110, the merchant 120, the acquirer 130, the issuer 150, and the payment network 170 may each be configured to communicate with one or more other elements of the system 100 via the one or more networks 105. The one or more networks 105 may include, but are not limited to, one or more of the following networks: a local area network (LAN), a wide area network (WAN) (e.g., the Internet), a mobile network, a virtual network, and/or any other public and/or private network known in the art capable of supporting communication among two or more of the elements of the system 100. In addition, and as further explained later, the user device 110 and the merchant 120 may be configured to communicate with one another using any type of communication known in the art, including, but not limited to, the following: contactless communication, Near Field Communication (NFC), wireless communication, cellular communication, communication via the one or more networks 105, and/or the like.

As similarly described above, the user 102 may utilize a payment card in order to perform a payment transaction with the merchant 120. The user 102 may be similar to the user mentioned above, such that the user 102 may be any entity known to those skilled in the art. For example, the user 102 may be an individual person, a family, a commercial entity, a company, a corporation, a governmental entity, a non-profit organization, and/or the like. Though FIG. 1 shows the user 102 as being an individual person, those skilled in the art will understand that the implementations disclosed herein can be applied to instances in which the user 102 is any other entity known in the art. Likewise, the merchant 120 may be similar to the merchant mentioned above, such that the merchant 120 may be any entity capable of offering one or more products for sale to the user 102. For example, the merchant 120 may be an individual person, a family, a commercial entity, a company, a corporation, a governmental entity, a non-profit organization, and/or the like. Further, the one or more products may be similar to the products described above.

The payment transaction performed between the user 102 and the merchant 120 may be any transaction known in the art. In particular, the payment transaction may refer to a transaction by the user 102 to purchase the one or more products from the merchant 120 using funds from a payment account linked to the payment card. As is known in the art, the payment transaction may be an in-person payment transaction and/or an online payment transaction between the user 102 and the merchant 120.

As similarly described above, the payment card may be any type of card known in the art, including a physical card or a virtual card. Examples of the payment card may include, but are not limited to, the following: a debit card, a credit card, a prepaid card, a virtual payment card, virtual payment numbers, virtual card numbers, a foreign exchange card, a charge card, a stored-value card, and/or the like. As mentioned above, the payment card may be linked with a payment account of the user 102, such that the user 102 can use the payment card to fund the payment transaction via the payment account. In particular, the user 102 may be an account holder of the payment account. Moreover, the payment account of the user 102 may be similar to the payment account described above, such that the payment account may include any type of financial account known to those skilled in the art that can be used to fund the payment transaction. For example, the payment account may be a banking account, a checking account, a savings account, a credit card account, a debit card account, a prepaid card account, a virtual payment account, and/or the like.

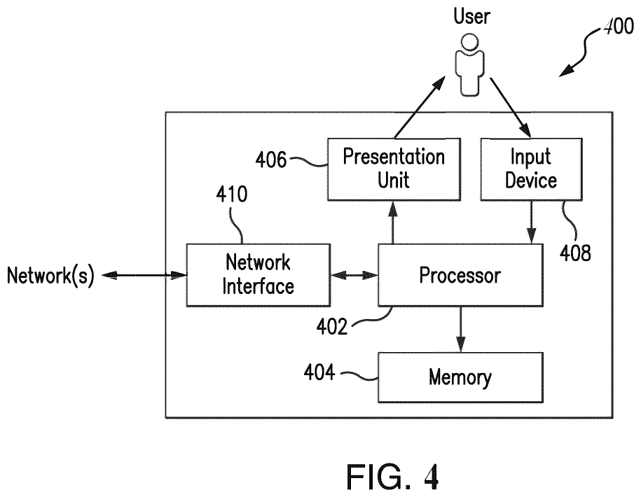

As shown, the user 102 may utilize the user device 110 to perform the payment transaction with the merchant 120 using the payment card. The user 102 may own, operate, and/or be associated with the user device 110, and the user device 110 may be any computing device known to those skilled in the art. For example, the user device 110 may be a mobile device (e.g., a smartphone), a wearable device (e.g., a smartwatch), and/or the like. Various implementations of the user device 110 are discussed later with respect to FIG. 4. Further, the user device 110 may be configured to perform one or more operations described herein, such as communicating with the merchant 120 and/or the issuer 150 via the one or more networks 105.

In particular, the user 102 may utilize an application 112 stored on the user device 110 to communicate with the issuer 150 to manage and authorize payment transactions associated with the payment card. The application 112 may be an issuer-provided application, such as a credit card issuer application or a bank-issued payment control application, that enables secure interaction with the issuer 150 for various financial services. Through the application 112, the user 102 may verify account details, receive transaction approvals, and perform authentication procedures required by the issuer 150. Additionally, the application 112 may facilitate secure messaging between the user 102 and the issuer 150, which may allow for transaction confirmations or account-related updates.

As similarly described above, the issuer 150 may be a financial institution (e.g., a bank, a credit card company, and/or the like) that maintains the payment account for the user 102 and issues the payment card associated with the account to the user 102. In particular, the issuer 150 may use one or more computing systems 151 to facilitate authentication of a force-post transaction. The one or more computing systems 151 may include any computing system known to those skilled in the art, such as one or more servers. Various implementations of the one or more computing systems 151 are discussed later with respect to FIG. 4. As further explained below, the issuer 150, through its one or more computing systems 151, may be configured to perform one or more operations described herein, including generating authentication credentials associated with a force-post transaction to be used by the payment network 170 to authenticate the force-post transaction.

As noted above, the merchant 120 may be any entity capable of offering one or more products for sale to the user 102. In particular, the merchant 120 may use one or more computing systems 121 to communicate with the user device 110 in order to perform the payment transaction, including by communicating with the user device 110. As noted above, using the one or more computing systems 121, the merchant 120 may communicate with the user device 110 using any technique known to those skilled in the art, including, but not limited to, contactless communication, NFC, wireless communication, cellular communication, and/or the like.

Further, the merchant 120 may use its one or more computing systems 121 to communicate with the acquirer 130 in order to further process a force-post transaction. The one or more computing systems 121 may include any computing system known to those skilled in the art, such as one or more merchant servers, one or more point-of-sale (POS) devices, one or more automated teller machines (ATMs), one or more point-of-interaction (POI) devices, one or more point-of-purchase (POP) devices, and/or the like. Various implementations of the one or more computing systems 121 are discussed later with respect to FIG. 4. In one example, the one or more computing systems 121 may include a single computing system configured to perform the operations of both a merchant POS device and a merchant server. In another example, the one or more computing systems 121 may include a separate merchant POS device and a separate merchant server configured to communicate with one another using any technique known in the art. As further explained below, the merchant 120, through its one or more computing systems 121, may be configured to perform one or more operations described herein.

As similarly described above, the acquirer 130 may be a financial institution (e.g., a bank, a credit card company, and/or the like) that provides one or more services for the processing of payment card-based transactions for the merchant 120. In particular, the acquirer 130 may use one or more computing systems 131 to facilitate authentication of a force-post transaction. The one or more computing systems 131 may include any computing system known to those skilled in the art, such as one or more servers. Various implementations of the one or more computing systems 131 are discussed later with respect to FIG. 4.

As shown in FIG. 1, the system 100 may also include the payment network 170. As similarly described above, the payment network 170 may refer to any network and/or collection of systems that uses one or more computing systems 171 to facilitate authentication of a force-post transaction. In particular, the payment network 170 may be a network and/or collection of systems configured to transfer funds through the use of cash-substitutes via any protocols or procedures known in the art. The one or more computing systems 171 may include any computing system known to those skilled in the art, such as one or more servers. Various implementations of the one or more computing systems 171 are discussed later with respect to FIG. 4. As further explained below, the payment network 170, through its one or more computing systems 171, may be configured to receive authentication credentials associated with a force-post transaction and authenticate the force-post transactions based on authentication credentials, and/or the like. Additionally, the payment network 170, through its one or more computing systems 171, may be configured to generate an authorization response based on authenticating the transaction, where the authorization response includes approval, rejection, or request for additional verification.

Additionally, in some implementations, the payment network 170 may be operated by and/or provided by an entity, where the entity may be related to at least one other element of the system 100. For example, the payment network 170 may be related to the issuer 150, such that the payment network 170 may perform one or more of the operations described herein for the issuer 150. In other implementations, the payment network 170 may be operated by and/or provided by an entity that is separate from and/or unrelated to other elements of the system 100. Examples of the payment network 170 may include those operated by Mastercard®.

The one or more computing systems mentioned above may be implemented using one or more software-based systems, one or more hardware-based systems, or combinations thereof. Further, the one or more computing systems mentioned above, including the user device 110, may be configured to perform the one or more operations described herein using one or more applications downloaded to, installed in, and/or active in these one or more computing systems. In addition, the one or more computing systems mentioned above, including the user device 110, may communicate with one another using any technique known to those skilled in the art. For example, though not shown in FIG. 1, these one or more computing systems may communicate with one another using one or more application programming interfaces (APIs) associated with the one or more applications. In another example, the one or more applications used by at least some of the computing systems may include a web browser, such that the web browser may be used to communicate with other computing systems of the system 100 via the one or more networks 105.

Moreover, although the system 100 is presented in one arrangement, other implementations may include one or more elements of the system 100 in different arrangements and/or with additional elements. For example, though one merchant 120 is shown in FIG. 1, those skilled in the art will understand that the implementations described herein may be applied to a plurality of merchants 120. In another example, though one user 102 is shown in FIG. 1, those skilled in the art will understand that the implementations described herein may be applied to a plurality of users 102.

### II. Operation

One or more elements of the system 100 may be used to perform one or more operations, such as those described below, to authenticate a force-post transaction. To address the risks associated with force-post transactions, system 100 is configured to implement a structured multi-party validation framework to authenticate a force-post transaction.

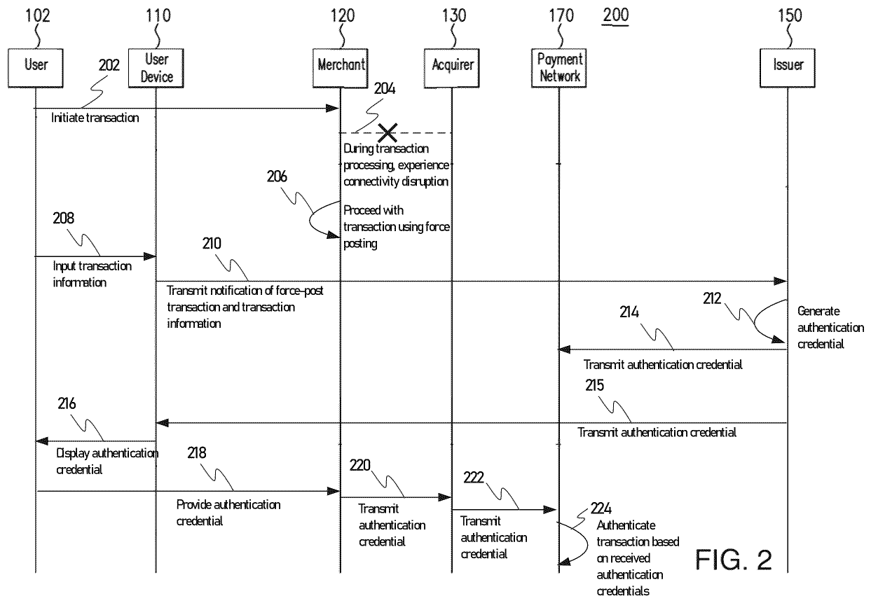

FIG. 2 illustrates a sequencing diagram 200 in accordance with implementations of various techniques described herein. In particular, the sequencing diagram 200 may represent an implementation of a transaction authentication process by the system 100, where the system 100 may be used to authenticate a force-post transaction. While the sequencing diagram is discussed with respect to FIG. 1, those skilled in the art will understand that implementations may not limited to the operation and/or the system discussed below.

At 202, the user 102 may initiate a transaction with the merchant 120. In one implementation, the transaction performed between the user 102 and the merchant 120 may be any transaction known in the art, including but not limited to the purchase of one or more products or services. The user 102 may initiate a transaction in various ways. In one implementation, the user 102 may swipe, insert, or tap a payment card at a POS system. In another implementation, the user 102 may utilize a wallet application to perform an in-person payment transaction with the merchant 120 using the payment card data stored on the user device 110. The user 102 may then perform the in-person payment transaction by using the wallet application to transmit the payment card data from the user device 110 to a merchant POS system using NFC technology. Yet, in another implementation, the user 102, using the user device 110, may initiate a transaction by entering payment card data for an online purchase through a digital payment interface (e.g., a merchant website or mobile application). Additionally, the user 102 may initiate a transaction through biometric authentication, voice commands via smart assistants, or contactless wearables.

In one implementation, the merchant 120, via the one or more computing systems 121, may capture and store transaction parameters, such as payment card data, a merchant identifier, and a transaction amount. In such cases, the one or more computing systems 121 of the merchant 120 (e.g., a POS system) may securely store these transaction parameters for subsequent transmission to the acquirer 130.

At 204, the merchant 120 (i.e., via the one or more computing systems 121) may attempt to communicate with the acquirer 130 in order to further process the transaction. However, in some instances, transaction processing may be disrupted due to connectivity issues, authorization failures, or other technical interruptions.

At 206, in response to the network connectivity disruption, the merchant 120 (i.e., via the one or more computing systems 121) may proceed with a force-post transaction to continue the transaction flow.

At 208, in response to the merchant 120 initiating the force-post transaction, the user 102 may provide transaction-related information to the user device 110. The transaction-related information may correspond to details pertaining to the transaction, such as a user identifier, a merchant identifier (e.g., a merchant name), a transaction amount, a category of the products or services the user 102 is attempting to purchase, and an image of the products being purchased. In one implementation, the user 102 may provide the transaction-related information via the application 112. For example, the user 102 may open the application 112 and, via a user interface of the user device 110, enter the transaction-related information. Alternatively, in one implementation, the merchant 120 (i.e., via the one or more computing systems 121) may send a prompt to the user device 110 using short-range communication technology, such as Bluetooth, NFC, or RFID, prompting the user 102 to enter the transaction-related information.

At 210, the user device 210 may transmit a notification indicating that the force-post transaction has been initiated to the one or more computing systems 151 of the issuer 150. In one implementation, the notification may also include the transaction-related information, which may be used by the issuer 150 for further authentication and processing. The notification may further include additional transaction data, such as the payment card data (e.g., the PAN), a transaction amount, a transaction date and time, a country code associated with the transaction, a geolocation of the transaction, and/or the like.

At 212, in response to receiving the notification, the issuer 150, using its one or more computing systems 151, may generate an authentication credential associated with the force-post transaction. The authentication credential may serve as a unique identifier for the force-post transaction and may be configured to indicate an initiation of the force-post transaction. In particular, the authentication credential may be configured to confirm authorization of the force-post transaction by the user 102 and the merchant 120 while validating the legitimacy of the force-post transaction.

In one implementation, the authentication credential may include a force-posting identifier (FPID) and an authorization code, both of which may serve as unique identifiers for the force-post transaction authentication. In a further implementation, the FPID may be a predefined identifier associated with the force-post transaction, while the authorization code may be a dynamically generated security code. In another implementation, the issuer 150 may generate authorization codes based on different security measures, cryptographic processes, or timing factors. For example, the issuer 150 may use a time-sensitive algorithm to generate authorization codes, incorporating variables such as a transaction amount, a merchant identifier, a time-based factor, and an issuer identifier.

At 214, the issuer 150, using its one or more computing systems 151, may transmit the authentication credential to the one or more computing systems 171 of the payment network 170 (e.g., via APIs, via the one or more networks 105, and/or the like). In one implementation, along with the authentication credential, the issuer 150 may transmit the additional transaction data (e.g., the payment card data, the transaction amount, the transaction date and time, the country code associated with the transaction, the geolocation of the transaction, etc.) for further processing. The payment network 170 may then process the authentication credential and store relevant information.

At 215, the issuer 150, using its one or more computing systems 151, may also transmit the authentication credential to the user device 110. At 216, the authentication credential may be displayed to the user 102. In one implementation, the application 112 may use a presentation unit of the user device 110 to display a prompt to the user 102, where the prompt may indicate the authentication credential has been received from the issuer 150. In another implementation, the authentication credential may be provided to the user device 110 via automated messaging or push notification mechanisms.

At 218, the user 102 may provide the authentication credential to the merchant 120. In one implementation, the user device 110 may transmit the authentication credential to the merchant 120 (i.e., via the one or more computing systems 121). For example, the user device 110 may transmit the authentication credential to the merchant 120 if the user device 110 and at least one computing device 121 (e.g., a merchant POS device) of the merchant 120 are sufficiently proximate to each other to perform a contactless transaction, such as through NFC technology. In such an implementation, the transmission of the authentication credential between the user 102 and the merchant 120 may occur in person, such as via a physical POS interaction. In another implementation, the user 102 may verbally provide the authentication credential to the merchant 120, such that an individual associated with the merchant 120 may input data relating to the authentication credential into the at least one computing device 121 during an in-person interaction. In a similar implementation, the user 102 may input the data relating to the authentication credential into at least one computing device 121 (e.g., a merchant POS device) during an in-person interaction. In yet another implementation, in an online transaction, the user 102 may submit the authentication credential to the merchant 120 through a digital payment interface (e.g., a merchant website or mobile application).

At 220, after network connectivity has been restored, the merchant 120, via the one or more computing systems 121, may transmit the authentication credential to the one or more computing systems 131 of the acquirer 130. In one implementation, the merchant 120 may also transmit the additional transaction data (e.g., the payment card data, the transaction amount, the transaction date and time, the country code associated with the transaction, the geolocation of the transaction, etc.) to the acquirer 130 for further processing. In another implementation, the merchant 120 may also transmit additional transaction-related metadata to the acquirer 130, where the additional transaction-related metadata may include merchant identifiers, transaction timestamps, device-specific authentication data, and/or the like.

In a further implementation, upon receiving the authentication credential and any additional information, the acquirer 130 may perform one or more preliminary validation checks to confirm that the authentication credential conforms to expected formats and standards before transmitting the authentication credential to the payment network 170. For example, these validation checks may include verifying the format integrity of the authentication credential, ensuring its association with an active transaction, and checking for indicators of potential fraud or authentication credential misuse. More specifically, the acquirer 130 may validate the merchant's credentials (e.g., merchant identifier, merchant category code, etc.) and/or examine the payment card data provided with the authentication credential. At 222, using its one or more computing systems 131, the acquirer 130 may transmit the authentication credential to the one or more computing systems 171 of the payment network 170.

At 224, the payment network 170, using its one or more computing systems 171, may authenticate the force-post transaction based on the authentication credentials received from the issuer 150 and the acquirer 130. After receiving an authentication credential, the payment network 170 may search for a corresponding authentication credential previously stored in association with the force-post transaction. For example, the retrieval process may involve querying a database or ledger storing authentication credentials associated with various transactions. In one implementation, the search may be conducted using the FPID and/or other unique data points (e.g., merchant identifiers, transaction identifiers, etc.) associated with the force-post transaction. For example, the payment network 170 (i.e., via the one or more computing systems 171) may obtain the FPID and/or other unique data points from the authentication credential received from the acquirer 130. The payment network 170 may then query its database or ledger for a stored authentication credential having a FPID and/or other unique data points that matches those obtained from the acquirer-received authentication credential. If the payment network 170 finds such a stored authentication credential, then the payment network 170 may retrieve the stored authentication credential and any associated information for further processing. In contrast, if the payment network 170 is unable to find such a stored authentication credential, then the payment network 170 stores the acquirer-received authentication credential and any associated information for later retrieval.

In one implementation, the payment network 170 may further compare the acquirer-received authentication credential with the retrieved authentication credential to determine whether the force-post transaction is legitimate. In one implementation, the authentication process may include determining whether the FPID and authorization code of the acquirer-received authentication credential matches the FPID and authorization code of the retrieved authentication credential. If such a match exists, then the payment network 170 may determine that the acquirer-received authentication credential is valid, and the payment network may then approve the force-post transaction. If such a match does not exist, then the payment network 170 may determine that the acquirer-received authentication credential is not valid, and the payment network 170 may then reject the force-post transaction.

In a further implementation, the authentication process may involve validating authorization codes of authentication credentials having the same FPIDs. In one example, the payment network 170 may be configured to determine whether the authorization code of the acquirer-received authentication credential was derived within an acceptable time window. If so, then the payment network 170 may determine that the acquirer-received authentication credential is valid, and the payment network may then approve the force-post transaction. Otherwise, the payment network 170 may determine that the acquirer-received authentication credential is not valid, and the payment network 170 may then reject the force-post transaction.

In another implementation, the payment network 170 may verify the structure, integrity, and metadata associated with the authentication credential. For example, the payment network 170 may apply predefined validation rules to confirm that the authentication credential corresponds to an active transaction request and has not been altered, reused fraudulently, or tampered with during transmission.

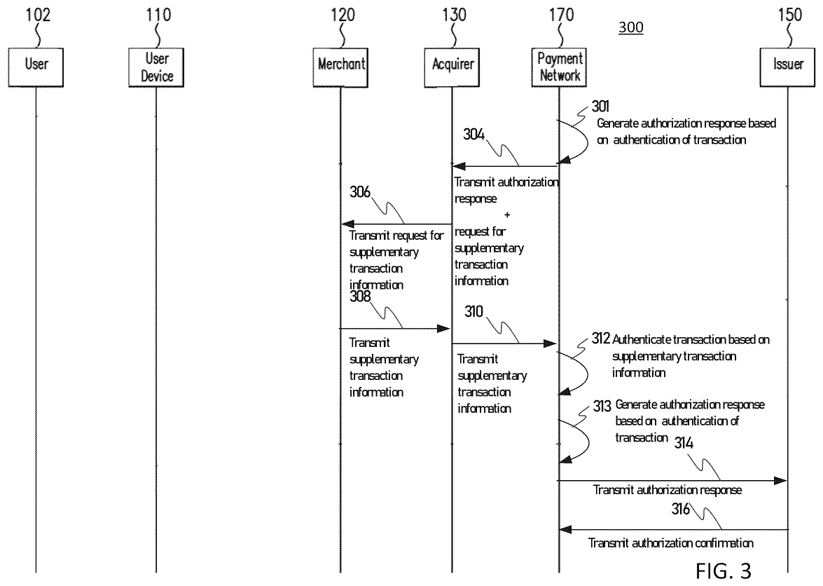

FIG. 3 illustrates a sequencing diagram 300 in accordance with implementations of various techniques described herein. In particular, the sequencing diagram 300 may represent an implementation of a process by the system 100, where the system 100 may be used to generate an authorization response for a force post transaction.

At 301, the payment network 170, using its one or more computing systems 171, may generate a first authorization response based on an authentication of the force-post transaction. In particular, the first authorization response may indicate whether the payment network 170 approved or rejected the force-post transaction. In a further implementation, the first authorization response may indicate that further verification may be required, such as for instances in which the payment network 170 rejected the force-post transaction.

At 304, for instances in which the first authorization response indicates a rejection of the force-post transaction, the payment network 170, using its one or more computing systems 171, may transmit the first authorization response to the one or more computing systems 131 of the acquirer 130. The payment network 170 may also transmit a request for supplementary transaction information to the acquirer 130. This supplementary transaction information may include merchant identifiers, transaction metadata, and/or time-based verification parameters.

At 306, the acquirer 130, using its one or more computing systems 131, may transmit the request for supplementary transaction information to the merchant 120 if the information is not available to the acquirer 130. At 308, the merchant 120 may, in response, transmit the supplementary transaction information to the one or more computing systems 131 of the acquirer 130. At 310, using its one or more computing systems 131, the acquirer 130 may transmit the supplementary transaction information to the one or more computing systems 171 of the payment network 170. In some implementations, the acquirer 130 may transmit the supplementary transaction information to the payment network 170 without having to request this information from the merchant 120.

At 312, the payment network 170, using its one or more computing systems 171, may authenticate the force-post transaction based on the supplementary transaction information. In one implementation, the payment network 170 may compare the received supplementary transaction information with associated information that had been retrieved along with the retrieved authentication credential. If at least a portion of the received supplementary transaction information matches the retrieved associated information, then the payment network may approve the force-post transaction. If such a match does not exist, then the payment network 170 may reject the force-post transaction.

At 313, the payment network 170, using its one or more computing systems 171, may generate a second authorization response based on authentication of the force-post transaction using the supplementary transaction information. In particular, the second authorization response may indicate whether the payment network 170 has approved or rejected the force-post transaction. If the payment network 170 has rejected the force-post transaction, then the payment network 170 may transmit the second authorization response to the acquirer 130 (not shown), such that the second authorization response indicates that the payment network 170 is declining to further process the force-post transaction.

At 314, if the payment network 170 has approved the force-post transaction, then the payment network 170, using its one or more computing systems 171, may transmit an authorization request to the one or more computing systems 151 of the issuer 150. In one implementation, if the payment network 170 generated a first authorization response indicating that the payment network 170 approved the force-post transaction, then the payment network 170 may also transmit the first authorization response with the authorization request. In such an implementation, steps 304-313 may be optional. In another implementation, if the payment network 170 generated a second authorization response indicating that the payment network 170 approved the force-post transaction, then the payment network 170 may also transmit the second authorization response with the authorization request. In addition, the authorization request transmitted to the issuer 150 may also include the authentication credential, the additional transaction data (e.g., the payment card data, the transaction amount, the transaction date and time, the country code associated with the transaction, the geolocation of the transaction, etc.), and/or the additional transaction-related metadata received from the acquirer 130.

After receiving the authorization request from the payment network 170, the issuer 150 may determine whether to proceed with final settlement or initiate further verification processes. In one implementation, based on the received authorization request, the issuer 150 (i.e., via the one or more computing systems 151) may generate an issuer authorization response (not shown). For a successful force-post transaction, the issuer 150 (i.e., via the one or more computing systems 151) may generate an issuer authorization response indicating that the transaction is approved. In particular, after the approval of the force-post transaction, the force-post transaction may be funded via a transfer of funds between the payment account of the user 102 and a financial account of the merchant 120. In contrast, for a failed force-post transaction, the issuer 150 (i.e., via the one or more computing systems 151) may generate an issuer authorization response indicating that the force-post transaction is declined.

In some implementations, the issuer 150 (i.e., via the one or more computing systems 151) may generate the issuer authorization response based on one or more financial assessments of the force-post transaction. The one or more financial assessments may include whether the payment account of the payment card is in good standing, whether the payment account of the payment card includes sufficient funds or credit, fraud scoring, and/or the like. In other implementations, the issuer 150 (i.e., via the one or more computing systems 151) may generate the issuer authorization response after attempting to validate the authentication credential, the additional transaction data (e.g., the payment card data, the transaction amount, the transaction date and time, the country code associated with the transaction, the geolocation of the transaction, etc.), and/or the additional transaction-related metadata received from the payment network 170. The issuer 150 may use any validation technique known in the art. If additional validation is required, the issuer 150 may flag the force-post transaction for further review by the acquirer 130 and/or an additional fraud detection system.

At 316, the issuer 150, using its one or more computing systems 151, may transmit the issuer authorization response to the payment network 170 (i.e., via the one or more computing systems 170). In one implementation, the issuer authorization response may also include instructions on how the payment network 170 should proceed, such as by further processing the force-post transaction for settlement, requesting additional verification, and/or flagging the transaction for further review. Further, using its one or more computing systems 171, the payment network 170 may transmit the issuer authorization response to the one or more computing systems 131 of the acquirer 130 (not shown).

Accordingly, in view of the implementations discussed above with respect to FIGS. 1-3, various implementations of a system and method for facilitating a force-post transaction are described herein. In some implementations, the described system and method may enhance the security and reliability of force-post transactions by incorporating authentication credentials that are generated by the issuer and validated through the payment network as part of the force-post authentication process. For example, in one implementation, upon receiving a notification of a force-post transaction from a user associated with an issuer, the issuer may generate a first authentication credential configured to indicate the initiation of the force-post transaction and provide the first authentication credential to the payment network. This may ensure that both the payment network and the issuer are aware of the force-post transaction early in the force-post transaction authentication process.

Additionally, in one implementation, the issuer may generate a second authentication credential configured to confirm authorization of the force-post transaction by the user and the merchant. The second authentication credential may then be provided to the payment network for authentication. This may ensure authorization of the force-post transaction by the user and the merchant during the force-post transaction authentication process. This dual-credential approach may provide additional verification and reduce the likelihood of disputes between the acquirer and the issuer.

Additionally, in one implementation, the payment network may authenticate the force-post transaction based on the first and second authentication credentials and generate an authorization response for the issuer based on the authentication process. In response, the issuer may then finalize clearing and settlement of the transaction or initiate further verification processes if necessary. By leveraging this structured authentication process, the described system and method may improve overall force-post transaction security and minimize unauthorized force-post transactions.

### III. Computing System

FIG. 4 illustrates a diagram of a computing system 400 in which one or more various technologies described herein may be incorporated and practiced. The computing system 400 may be any computing system known to those skilled in the art. For example, the computing system 400 may include one or more servers, workstations, personal computers, laptops, tablets, smartphones, personal digital assistants (PDAs), and/or the like. In one implementation, the computing system 400 may include a single computing system. In another implementation, the computing system 600 may include multiple computing systems located in close proximity and/or distributed over a geographic region, where the computing systems may be configured to function as described herein.

The computing system 400 can be used to implement one or more of the computing systems discussed above, such as the devices and systems 110, 121, 131, 151, and 171. Those skilled in the art will understand that the system 400 may use different computing systems and/or arrangements of computing systems than those described with respect to FIG. 4. In addition, different components and/or arrangements of components may be used in other computing systems.

Referring to FIG. 4, the computing system 400 may include a processor 402 and a memory 404 coupled to and/or in communication with the processor 402. The processor 402 may include one or more processing units (e.g., in a multi-core configuration and/or the like). For example, the processor 402 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 404, as described herein, may include one or more devices that permit data, instructions, etc., to be stored therein and retrieved therefrom. The memory 404 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 404 may be configured to store, without limitation, images, private and/or public keys, public/private key pairs, identity records, certified and/or certification records, hashed data, signed data, one or more data structures, and/or other types of data suitable for use as described herein. Furthermore, in various implementations, computer-executable instructions may be stored in the memory 404 for execution by the processor 402 to cause the processor 402 to perform one or more of the functions described herein, such that the memory 404 may be a physical, tangible, and non-transitory computer readable storage media. Such instructions may be used to improve the efficiencies and/or performance of the processor 402 and/or other computer system components configured to perform one or more of the various operations herein. It should be appreciated that the memory 404 may include a variety of different memories, each implemented in one or more of the functions or processes described herein.

The computing system 400 may also include a presentation unit 406 that is coupled to and/or in communication with the processor 402. However, it should be appreciated that the computing system 400 could include output devices other than the presentation unit 406 and/or the like. The presentation unit 406 may output information to a user, such as by using a visual output. Further, one or more interfaces may be displayed at computing system 400, including at presentation unit 406, to display certain information. The one or more interfaces may be defined by the one or more applications mentioned above, defined by websites, defined by mobile applications, and/or the like. In addition, the one or more interfaces may be used to capture images of documents, capture selfies, capture biometrics, and/or the like. The presentation unit 406 may include, without limitation, a liquid crystal display (LCD), a light-emitting diode (LED) display, an organic LED (OLED) display, an “electronic ink” display, speakers, and/or the like. In some implementations, the presentation unit 406 may include multiple devices.

In addition, the computing system 400 may include an input device 408 configured to receive and/or acquire one or more inputs from a user (i.e., user inputs), such as in response to prompts from the one or more applications described above. The one or more inputs may include images of documents, images of a user (e.g., biometric data), and/or the like. The input device 408 may include a single input device or multiple input devices. The input device 408 may be coupled to and/or in communication with the processor 402. The input device 408 may include, for example, a keyboard, a pointing device, a mouse, a stylus, a camera, fingerprint scanner, a touch sensitive panel (e.g., a touch pad, a touch screen, and/or the like), acquisition equipment as described above, another computing system, an audio input device, or combinations thereof. In one implementation, a touch screen, such as that included in a tablet, a smartphone, or similar device, may behave as both a presentation unit and an input device. As mentioned above, the computing system may include and/or configured to be coupled to any equipment used to acquire one or more images of documents and/or biometric data. Such equipment may include a camera, a biometric sensor (e.g., fingerprint sensor, iris scanner, palm scanner, and/or the like), and/or any other device configured to acquire such data.

Further, the illustrated computing system 400 may include a network interface 410 coupled to and/or in communication with the processor 402 and the memory 404. The network interface 410 may include, without limitation, a wired network adapter, a wireless network adapter (e.g., NFC adapter, a Bluetooth adapter, and/or the like), a mobile network adapter, and/or other devices capable of communicating to one or more different devices of the networks described herein. Further, in some implementations, the computing system 400 may include the processor 402 and one or more network interfaces incorporated into or with the processor 402. In some implementations, the computing system 400 may include global positioning system (GPS) capability, whereby the computing system 400 may determine its current geographic location, perform mapping applications, and/or the like.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The currently pending claims are as follows:

1. A method for authenticating a transaction between an issuer associated with a user and an acquirer associated with a merchant, the method implemented using a payment network comprising at least one processor in communication with a memory, the method comprising:
receiving, from the issuer, a first authentication credential associated with the transaction, wherein the first authentication credential is generated by the issuer and configured to indicate an initiation of the transaction;
receiving, from the acquirer, a second authentication credential associated with the transaction, wherein the second authentication credential is generated by the issuer and provided to the user for subsequent transmission to the merchant, and wherein the second authentication credential is configured to confirm authorization of the transaction by the user and the merchant;
authenticating the transaction based on the first and second authentication credentials;
generating an authorization response based on authenticating the transaction; and
transmitting the authorization response to the issuer.

2. The method of claim 1, wherein the transaction is a force-post transaction.

3. The method of claim 1, wherein the first authentication credential comprises a force-posting identifier and an authorization code.

4. The method of claim 1, wherein receiving the first authentication credential further comprises receiving the first authentication credential from the issuer via an application programming interface.

5. The method of claim 1, wherein the second authentication credential comprises a force-posting identifier and authorization code.

6. The method of claim 1, wherein the second authentication credential is transmitted by the merchant to the acquirer.

7. The method of claim 1, wherein authenticating the transaction further comprises:
comparing the first authentication credential and the second authentication credential.

8. The method of claim 1, wherein the authorization response includes approval, rejection, or request for additional verification.

9. A method for processing transactions within a transaction authentication framework including a payment network communicatively connected between an issuer and an acquirer over a distributed computing network, the method comprising:
receiving, by the issuer associated with a user, a notification of a transaction, the transaction initiated by the user and directed to a merchant associated with the acquirer;
in response to receiving the notification, generating, by the issuer, a first authentication credential configured to indicate initiation of the transaction and a second authentication credential configured to confirm authorization of the transaction by the user and the merchant;
transmitting, by the issuer, the first authentication credential to the payment network and the second authentication credential to the user for subsequent transmission to the merchant;
receiving, by the acquirer, the second authentication credential from the merchant;
transmitting, by the acquirer, the second authentication credential to the payment network;
authenticating, by the payment network, the transaction based on the first and second authentication credential;
generating, by the payment network, an authorization response based on authenticating the transaction; and
transmitting, by the payment network, the authorization response to the issuer.

10. The method of claim 9, wherein the transaction is a force post transaction.

11. The method of claim 9, wherein the first authentication credential comprises a force-posting identifier and authorization code.

12. The method of claim 9, wherein the first authentication credential is transmitted to the payment network via an application programming interface.

13. The method of claim 9, wherein the second authentication credential comprises a force-posting identifier and authorization code.

14. The method of claim 9, wherein the second authentication credential is transmitted by the merchant to the acquirer.

15. The method of claim 9, wherein authenticating the transaction further comprises:
comparing the first authentication credential and the second authentication credential.

16. The method of claim 9, wherein the authorization response includes approval, rejection, or request for additional verification.

17. At least one non-transitory computer-readable storage media having computer-executable instructions embodied thereon, wherein when executed by an intermediary transaction processing system including at least one processor in communication with a memory, the computer-executable instructions cause the at least one processor to:
receive, from the issuer associated with a user, a first authentication credential associated with a transaction between the user and a merchant, wherein the first authentication credential is generated by the issuer and configured to indicate an initiation of the transaction;
receive, from the acquirer, a second authentication credential associated with the transaction, wherein the second authentication credential is generated by the issuer and provided to the user for subsequent transmission to the merchant, and wherein the second authentication credential is configured to confirm authorization of the transaction by the user and the merchant;
authenticate the transaction based on the first and second authentication credentials;
generate an authorization response based on authenticating the transaction; and
transmit the authorization response to the issuer.

18. The at least one non-transitory computer-readable storage media of claim 17, wherein the transaction is a force post transaction.

19. The at least one non-transitory computer-readable storage media of claim 17, wherein the first authentication credential comprises a force-posting identifier and an authorization code.

20. The at least one non-transitory computer-readable storage media of claim 17, wherein the second authentication credential comprises a force-posting identifier and authorization code.
